(19) United States
(12) Patent Application Publication
(10) Pub. No.: US 2025/0363136 A1
(43) Pub. Date: Nov. 27, 2025

(54) SYSTEMS AND METHODS FOR DETERMINING SIMILAR INCIDENTS UTILIZING TEMPORAL ASSOCIATIONS

(71) Applicant: Fidelity Information Services, LLC, Jacksonville, FL (US)

(72) Inventors: Ranadhir GHOSH, St. Johns, FL (US); Arindam MALLIK, Karnataka (IN); John PLATAIS, Menomonee Falls, WI (US)

(21) Appl. No.: 19/292,324

(22) Filed: Aug. 6, 2025

Related U.S. Application Data
(63) Continuation-in-part of application No. 18/478,106, filed on Sep. 29, 2023, now Pat. No. 12,405,805.

(51) Int. Cl. G06F 16/28

(52) U.S. Cl. CPC G06F 16/285; G06F 16/288

(57) ABSTRACT

A computer-implemented method for determining related information technology event data by applying temporal associations includes: receiving a data object including a short description indicating an occurrence of a current incident associated with a configurable item; applying a first machine learning model to the short description to determine a first cluster associated with the data object; receiving a plurality of data object indicating occurrences of current incidents that occurred within a set period of time of the current incident, the plurality of data objects including a plurality of short descriptions; applying the first machine learning model to the short descriptions to determine associated clusters; determining, based on association rules and the associated clusters, a set of similar data objects from the plurality of data objects; assigning a set of associations between the data object and each of the set of similar data objects; and storing the set of associations.

### CROSS-REFERENCE TO RELATED APPLICATION

This application is a continuation-in-part of U.S. application Ser. No. 18/478,106, filed Sep. 29, 2023, the disclosure of which is incorporated by reference herein in its entirety.

### TECHNICAL FIELD

Various embodiments of the present disclosure relate generally to information technology (IT) management systems and, more particularly, to systems and methods for determining historically similar incidents using temporal associations.

### BACKGROUND

In computing systems, for example computing systems that perform financial services and electronic payment transactions, programing changes may occur. For example, software may be updated. Changes in the system may lead to incidents, defects, issues, bugs or problems (collectively referred to as incidents) within the system. These incidents may occur at the time of a software change or at a later time. These incidents may be costly for the company as users may not be able to use the services and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company.

Incidents within a system may be related and may repeat themselves from time to time. Identifying a previous incident that was similar to a current incident may lead to an incident being resolved more quickly (e.g., updates performed by the previous issue may be utilized to address the new issue). Many existing computing systems do not have the ability to find historically similar incidents in order to analyze new incidents. The present disclosure is directed to addressing this and other drawbacks to the existing computing system incident analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, a computer-implemented method for determining related information technology event data by applying temporal associations comprises: receiving a data object indicating an occurrence of a current incident associated with a configurable item, the data object including a short description; applying a first machine learning model to the short description of the data object to determine a first cluster associated with the data object; receiving a plurality of data object indicating occurrences of current incidents that occurred within a set period of time of the current incident, the plurality of data objects including a plurality of short descriptions; applying the first machine learning model to the short descriptions of the plurality of data objects to determine associated clusters for each of the plurality of data objects; determining, based on association rules and the associated clusters, a set of similar data objects from the plurality of data objects; assigning a set of associations between the data object and each of the set of similar data objects; and storing the set of associations.

In some aspects, a system for determining related information technology event data in a system comprises: a memory having processor-readable instructions stored therein; and at least one processor configured to access the memory and execute the processor-readable instructions to perform operations including: receiving a data object indicating an occurrence of a current incident associated with a configurable item, the data object including a short description; applying a first machine learning model to the short description of the data object to determine a first cluster associated with the data object; receiving a plurality of data object indicating occurrences of current incidents that occurred within a set period of time of the current incident, the plurality of data objects including a plurality of short descriptions; applying the first machine learning model to the short descriptions of the plurality of data objects to determine associated clusters for each of the plurality of data objects; determining, based on association rules and the associated clusters, a set of similar data objects from the plurality of data objects; assigning a set of associations between the data object and each of the set of similar data objects; and storing the set of associations.

In some aspects, a non-transitory computer readable medium storing processor-readable instructions which, when executed by at least one processor, cause the at least one processor to perform operations including: receiving a data object indicating an occurrence of a current incident associated with a configurable item, the data object including a short description; applying a first machine learning model to the short description of the data object to determine a first cluster associated with the data object; receiving a plurality of data object indicating occurrences of current incidents that occurred within a set period of time of the current incident, the plurality of data objects including a plurality of short descriptions; applying the first machine learning model to the short descriptions of the plurality of data objects to determine associated clusters for each of the plurality of data objects; determining, based on association rules and the associated clusters, a set of similar data objects from the plurality of data objects; assigning a set of associations between the data object and each of the set of similar data objects; and storing the set of associations.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence model to predict and troubleshoot incidents in a system, according to one or more embodiments.

FIG. 2 depicts a set of flowcharts for generating models to predict clusters, according to one or more embodiments.

FIG. 3 depicts a flowchart for a method of generating a transaction dataset, according to one or more embodiments.

FIG. 4A depicts an exemplary graph of transaction datasets, according to one or more embodiments.

FIG. 4B depicts an exemplary graph of incident clusters, according to one or more embodiments.

FIG. 4C depicts an exemplary graph of windows for clusters, according to one or more embodiments.

FIG. 5 depicts a flowchart for a method of generating an association ruleset, according to one or more embodiments.

FIG. 6 depicts a flowchart of generating and storing an association ruleset, according to one or more embodiments.

FIG. 7 depicts a flowchart for a method of finding historically similar incident, according to one or more embodiments.

FIG. 8 depicts a flowchart 800 for a method of determining related information technology event data by applying temporal associations, according to one or more embodiments.

FIG. 9A-9G depicts exemplary graphs of transaction datasets and association rulesets, according to one or more embodiments.

FIG. 10 illustrates a computer system for executing the techniques described herein, according to one or more embodiments of the present disclosure.

### DETAILED DESCRIPTION OF EMBODIMENTS

Various embodiments of the present disclosure relate generally to information technology (IT) management systems and, more particularly, to systems and methods for determining historically similar incidents using temporal associations.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The system described herein may be configured to analyze and/or process event data for an IT system. The system described herein may, for example, receive a stream of event data over periods of time. Event data may include but is not limited to: (1) an incident, (2) an alert, (3) change data, (4) a problem, and/or (5) anomaly.

An incident may be an occurrence that can disrupt or cause a loss of operation, services, or functions of a system. Incidents may be manually reported by customers or personnel, may be automatically logged by internal systems, or may be captured in other ways. An incident may occur from factors such as hardware failure, software failure, software bugs, human error, and/or cyber attacks. Deploying, refactoring, or releasing software code may, for example, cause an incident. An incident may be detected during, for example, an outage or a performance change. An incident may include characteristics, where an incident characteristic may refer to the quality or traits associated with an incident. For example, incident characteristics may include, but is not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is effected, what category/subcategory is affected, and/or what assigned group is the incident. The incident may further include metadata indicating an assigned Line of Business (“LOB”), where the LBO refers to a specific area of function that the incident pertains to or affects. For example, it may indicate a subgroup or group of a field such as relating to finance.

An alert may refer to a notification that informs a system or user of an event. An alert may include a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

Change data may refer to information that describes a modification made to data within a system or database. Change data may track the changes that occur over one or more periods of time. Problem data may refer to any data that causes issues or impedes a system's normal operations. Anomaly data may refer to data that indicates a deviation of a system from a standard or normal operation.

Event data may be associated with one or more configurable items (CIs). A configurable item (CI) may refer to a component of a system that can be identified as a self-contained unit for purposes of change control and identification. For example, a particular application, service, particular product, or server, may be defined by a CI.

For example, an information technology (IT) management system may receive incidents (e.g., data objects indicating occurrences of incidents) at invariable rates throughout the day. When incidents are received, it may be unclear as to how a particular incident relates to previous incidents. Better understanding the relationship between received incidents, in comparison to similar past incidents, may assist a user or a system in identifying and potentially addressing incidents for a system.

Processing a vast amount of information, such as incidents, to produce meaningful and actionable insights into IT operations may be valuable to organizations. As IT management systems utilize sophisticated tools and sensors, billions of data points may be received, and information overload may become an issue to be resolved. The systems and methods described herein may enable identification of historically similar incidents to provide additional insights. The historically similar incidents may help a user to better understand the relationships between various incidents and may provide insights into potential solutions.

As discussed above, identifying and resolving current incidents in a system may be crucial to fixing and/or most efficiently running a system. Identifying and analyzing solutions to similar incidents may assist a user and/or system in determining a solution to a current incident. Current systems may not be capable of accurately and efficiently finding similar historical incidents.

In some examples, when a single issue occurs within a system, the single issue may lead to the generation of a plurality of event data (e.g., one or more incident, alerts, changes, and/or problems as represented by data objects). In some examples, the event data may be interrelated (e.g., associated). By analyzing how incidents and other event data occur at similar times, resolutions of event data may show that event data that occurs at similar times may have a similar root cause. The system described herein may be configured to categorize event data (as related to incidents) based on descriptions and temporal aspects. The system described herein may be configured to receive large amounts of event data (e.g., hundreds or thousands of event data per hour) and to associate/determine similar event data. This may allow for additional filtering of retrieved event data. By grouping similar event data (as related to a particular issue with the system), this may lead to faster resolution of event data.

The system described herein may, for each received incident(s) (e.g., each received incident data objects), analyze the short description(s) and assign the incident to one or more clusters based on the short description. These assignations may help with associating linked CIs of incidents and event data within a same cluster. This may help analyze orphaned incidents such as incidents with an incorrect or unassigned CI. The system described herein may cluster a received to each event data type such as Incident->Incident, Incident->Problem, Incident->Change, and Incident->Alert correlation. Based on cluster numbers, and while incorporating an association ruleset and confidence score, the system described herein may make a dynamic representation, at any point of time, of connected event data based on the determined clusters and associations. In some examples, the system may output graphical visualizations of the relationships/associations. The system may even be configured to work even in scenarios where an overall database is down for linking event data and the system may retain relationships such that there will be no loss of information (e.g., a relationship between an incident-incident, for example may be determined and saved dynamically). The system may implement one or more machine learning models to operate the system described herein.

The system described herein may investigate if there are uncaptured relationships between unrelated CIs with event data with respect to time and provide a list of suggested Cis/event data to further investigate. These CIs may fall under different hierarchies or may be missing Line of Business/hierarchy information entirely. When a CI is impacted by an incident, we investigate other CIs impacted by similar incidents and other event types (problems, changes, alerts) from the past and assign a confidence score, the confidence score measuring a level of relationships between event data.

The system described herein may further incorporate a next level of filtering that involves analyzing incident types and comparing them with the current incident and its affected CI.

From here, the concept called temporal association may be implemented, where a temporal association rule expresses that a set of incidents tends to appear along with another set of incidents at the same transactions row, in a specific time frame which is defined as window here. A list of events (say, incidents) with opened status are fetched for a certain duration (e.g., 60 days.). Then, a window may be defined (e.g., 30 mins) with a sliding duration (e.g., 5 mins.)—then those open incidents may be logged within the window in transaction row and respective predicted cluster #column is set to 1. This process may be repeated for all windows starting from a starting date and continuing on a sliding duration gap. Once all transaction rows are defined with 1 or 0 entries in each cell (means transaction dataset is generated), the system may next identify association rules (which is again sorted by confidence score in descending order) between each cluster. Finally, as explained earlier, incident type (i.e., clusters) under each suggested CIs may be validated with the association with input incident type, where mismatched incidents are removed under the suggested CIs, again, if any events corresponding to CI do not associate with input incident type, then the CI entry will be removed.

In scenarios where there are huge number of related open incidents under same lob of input major incident, processing time to find association may take time. One or more embodiments described herein may determine historically similar incidents by considering temporal association between event data. This may allow for incidents to be associated more effectively than traditional approaches.

One or more embodiments described herein may include a system configured to receive an incident (e.g., an incident data object) as input. When an incident is received, a clustering algorithm (e.g., by a clustering machine learning model) may be applied to the short description to determine an assigned cluster number. For example, a cluster number of 7 may be assigned to the received incident. Each cluster may represent a set of incidents that have a most similar short description. Once assigned to a cluster, an association ruleset may be applied to the received incident.

The association ruleset may have been generated by analyzing sets of historical incident data, problem data, alert data, and change data. Each of these sets of historical event data (e.g., incident data, problem data, alert data, and change data) may previously have been analyzed by applying separate clustering models (e.g., one of four clustering models) to each respective set of historical event data. This may include applying a clustering model to the short descriptions of each data type to determine groupings of similar historical incident data, similar problem data, similar alert data, and similar change data. Each data type may have had a separate clustering model applied. There may be a set of clusters determined for each type of event data (e.g., four respective sets of clusters, one for each event data type). After the historical event data has all been assigned to a respective cluster, the association ruleset may be generated by applying a frequency pattern growth algorithm to moving windows of the historical event data to learn which clusters occur together. In particular, the frequency pattern growth algorithm may be applied to tables of the cluster data for the historical event data. The association ruleset may thus learn, within particular windows, which clusters of each data type frequently occur together. Further, the frequency pattern growth algorithm may assign confidence levels to how often certain clusters appear together. In an example case, the algorithm may learn that an incident assigned to cluster 7 may frequently occur within a same window as problem data assigned to cluster 33 and alert data assigned to cluster 47. It is noted that each data type has a separate list of clusters. The system may compare incident clusters to other incident includers, alert clusters, problem clusters, and change data clusters.

When the system described herein receives an incident, and after a clustering is performed, it may apply the learned association rules to determine a set of related event data. For example, as the received incident was assigned to cluster 7, the system may retrieve all other event data that occurred within a set period of time both before and after the incident was received. Each of the event data received may have a clustering model applied and an assigned cluster. The association ruleset may be applied to analyze the event data occurring at a similar time and to identify event data that has a cluster associated with the incident based on the association ruleset. This data may then be associated with the initial received incident data. For example, all problem data associated with cluster 33 and all alert data associated with cluster 47 within the set period of the incident occurring may be retrieved and associated with the incident.

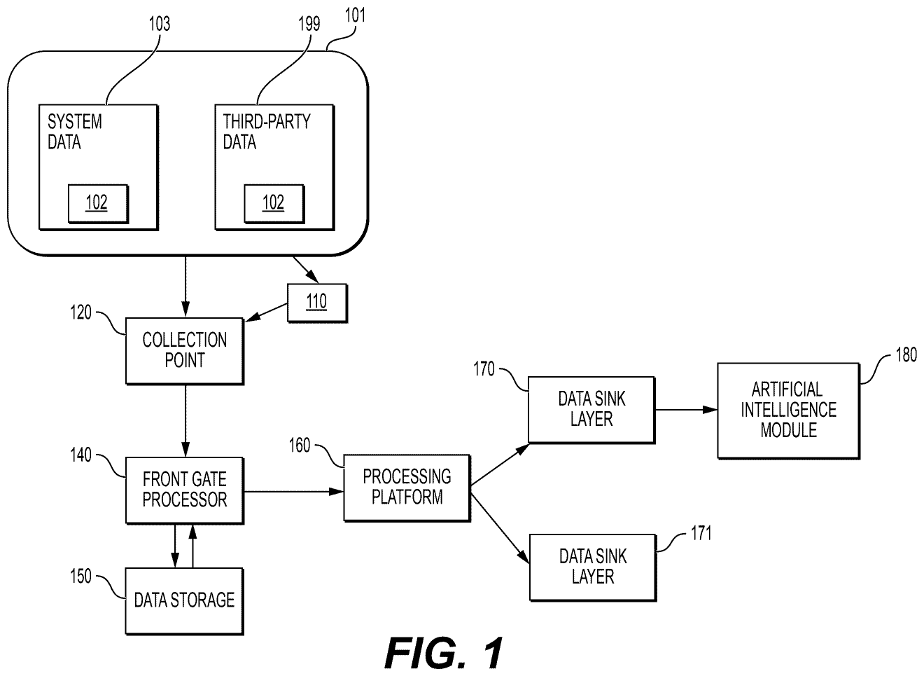

FIG. 1 depicts an exemplary system overview for a data pipeline for an artificial intelligence model to predict and troubleshoot incidents in a system, according to one or more embodiments. For example, the data pipeline system 100 may aggregate and send incident data to an artificial intelligence module 180, wherein the artificial intelligence module 180 is configured to aggregate and map incident characteristics into daily incident proles using feature engineering and/or multiple level clustering. The data pipeline system 100 may be a platform with multiple interconnected components. The data pipeline system 100 may include one or more servers, intelligent networking devices, computing devices, components, and corresponding software for aggregating and processing data. The data pipeline system 100 may include models configured to determine lists of historically similar incidents may implementing temporal associations between event data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180.

The data source 101 may include in-house data 103- and third-party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may, for example, be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may, for example, be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may, for example, be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., sink layer 170 and/or sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., data sink layer 170 and data sink layer 171). Incident data 102 processed from processing platform 160 may be transmitted to and stored in data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. Data sink layer 170 may store incident data 102 with several different formats. For example, data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster). Further processing may thus be performed prior to the processed data being received by an artificial intelligence module 180.

The data pipeline system 100 may include an artificial intelligence module 180. The artificial intelligence module 180 may include a machine-learning component. The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

The system described herein may include a machine learning model (e.g., a clustering model) for each type of event data (e.g., incident, change, problem, and alert). Each of these models may be configured to assign the respective event data to a particular cluster based on an associated short description. This may allow for each received event data object to be immediately assigned to a cluster. The clustering models may for example be k-means clustering models.

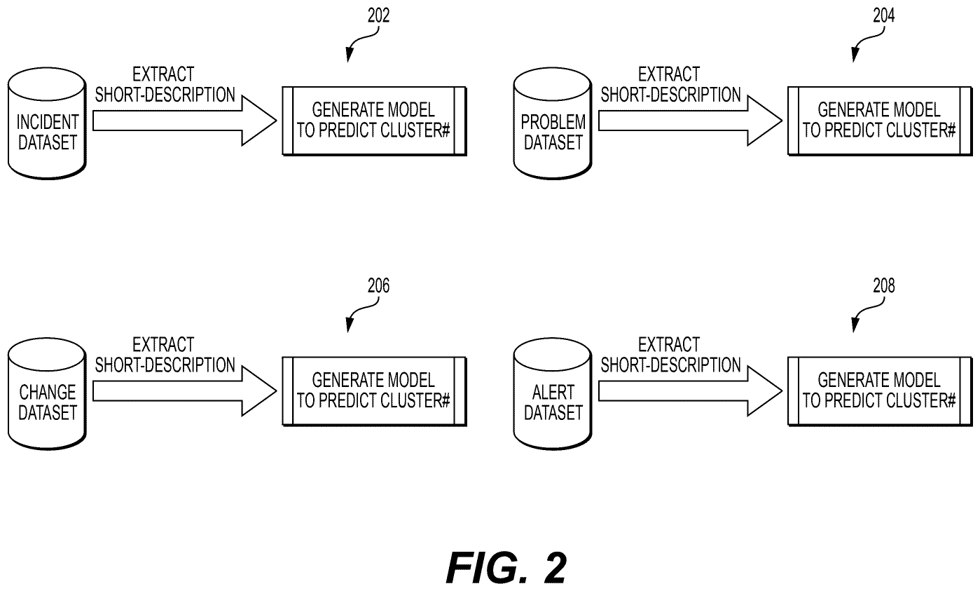

FIG. 2 depicts a set of flowcharts for generating models to predict clusters, according to one or more embodiments. Each of the models of FIG. 2 may for example be located in the artificial intelligence module 180 of FIG. 1. Each of the models may be configured to generate, based on a respective short description associated with each event data, a cluster number. For example, graph 202 displays how when an incident is received, the short description may be extracted and utilized to generate/train a model to cluster similar incidents based on similar short descriptions. The generated model may be configured to associate particular incidents with a cluster based on the short description of the cluster.

Graph 204 may display how when a problem is received, the short description may be extracted and utilized to generate/train a model to cluster similar problems based on similar short descriptions. The generated model may be configured to associate particular problems with a cluster based on the short description of the cluster.

Graph 206 may display how when a change data is received, the short description may be extracted and utilized to generate/train a model to cluster similar changes based on similar short descriptions. The generated model may be configured to associate particular changes with a cluster based on the short description of the cluster.

Graph 208 displays how when an alert is received, the short description may be extracted and utilized to generate/train a model to cluster similar alerts based on similar short descriptions. The generated model may be configured to associate particular incidents with a cluster based on the short description of the cluster. Each of the models generated in FIG. 2 may be utilized in the system described herein to assign cluster numbers to particular event data.

The system described herein may include and implement the set of models to define clusters as described above in FIG. 2. Next, the system described herein may generate a transaction dataset for a set of event data based on cluster numbers with defined window duration. The transaction dataset may further be utilized to generate association rules as will be described below.

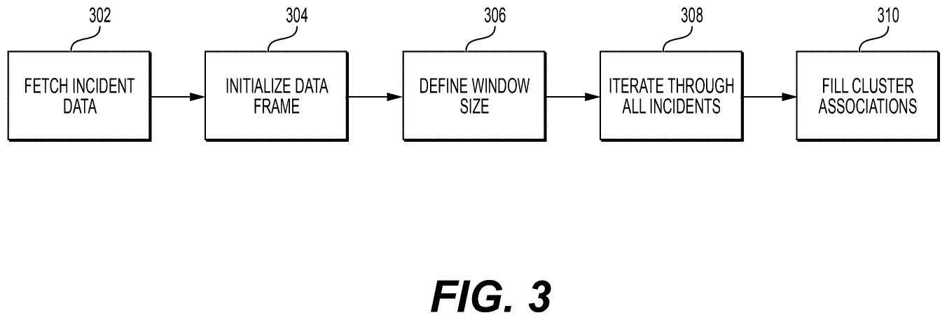

FIG. 3 depicts a flowchart for a method of generating a transaction dataset, according to one or more embodiments. The method of FIG. 3 may be performed by the system of FIG. 1.

Step 302 may include the system fetching incident data that has occurred over a set period of time. For example, this may include receiving all incident data (both major and non-major) received through data source 101 within the past year. This may include incident data that is in progress, new, on-hold status, and off, as well as resolved and closed before the current date/time.

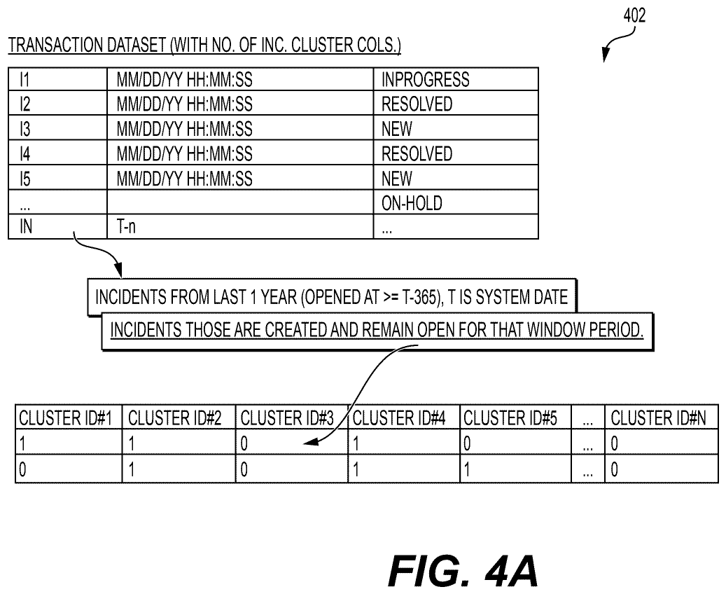

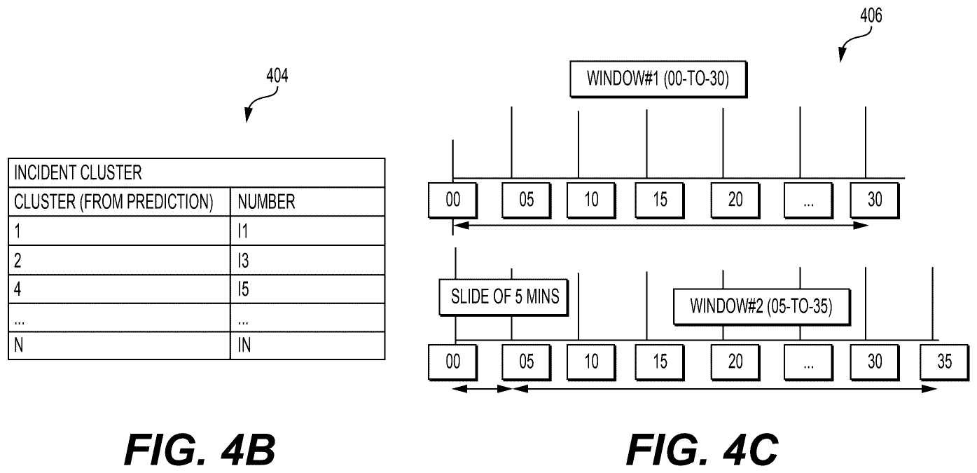

Step 304 may include initializing a data frame. The data frame may be a database such as a graph to store all incident data from step 302. This may include inputting all received data into a dataset graph as shown in the graph 402 of FIG. 4A.

Step 306 may include defining a window size to analyze the incident data by. For example, the window size of x may be set as thirty minutes and may have a sliding window of y that may be set as five minutes. FIG. 4C may include a graph 406 displaying exemplary windows and how a window may slide.

Step 308 may include iterating through all incidents fetched at step 302. This may include reviewing all received incidents in assigned windows, and then sliding the windows to analyze each new sliding window. This step may first identify window_incident lists, corresponding to the x-mins window. For example, the first thirty minutes (e.g., window x) of the received data may be examined. If no incidents are found, then skip to next window considering slide duration. This means that the window may slide (e.g., by five minutes) to review incident data received from five to thirty-five minutes. While analyzing these respective windows, the system may only review those incident(s) that are currently resolved/closed but resolved after then window OR status in In-Progress/New/On-hold etc.

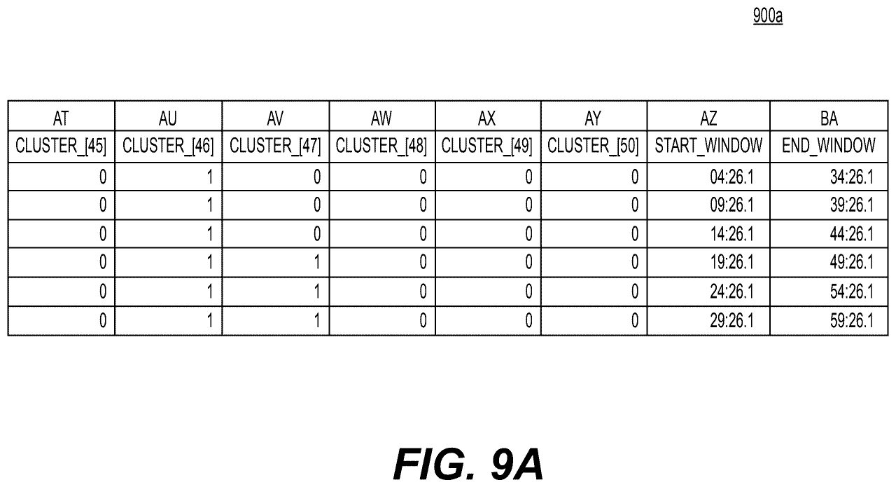

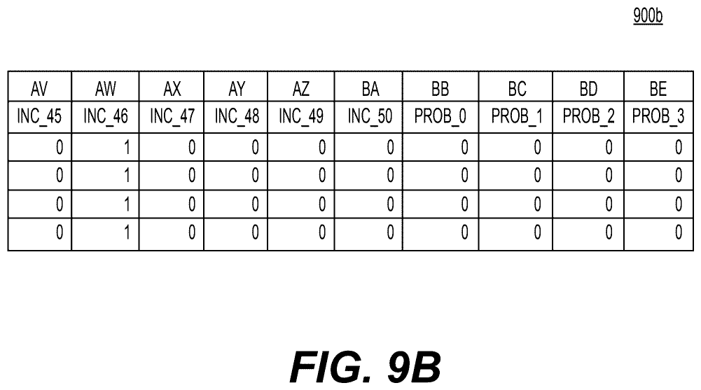

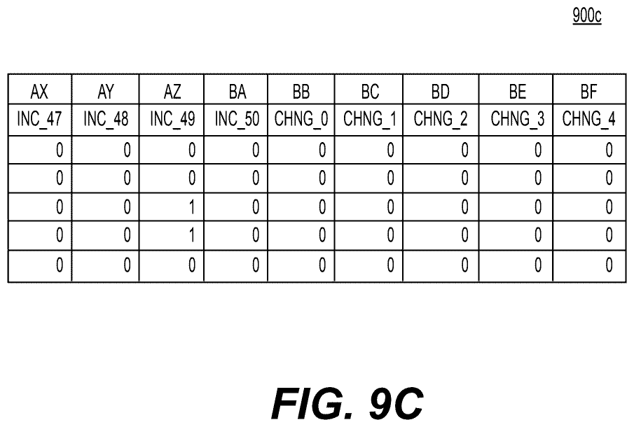

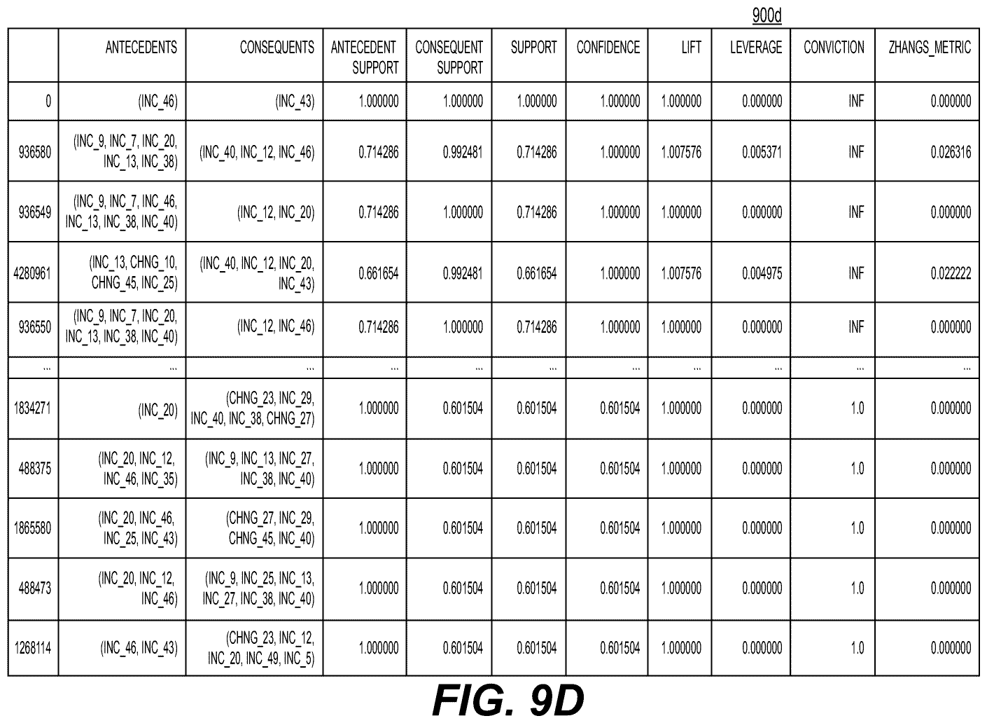

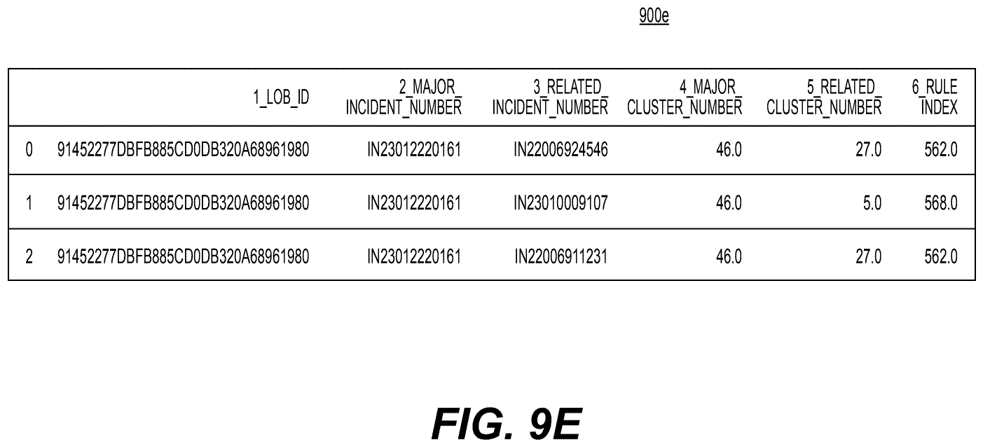

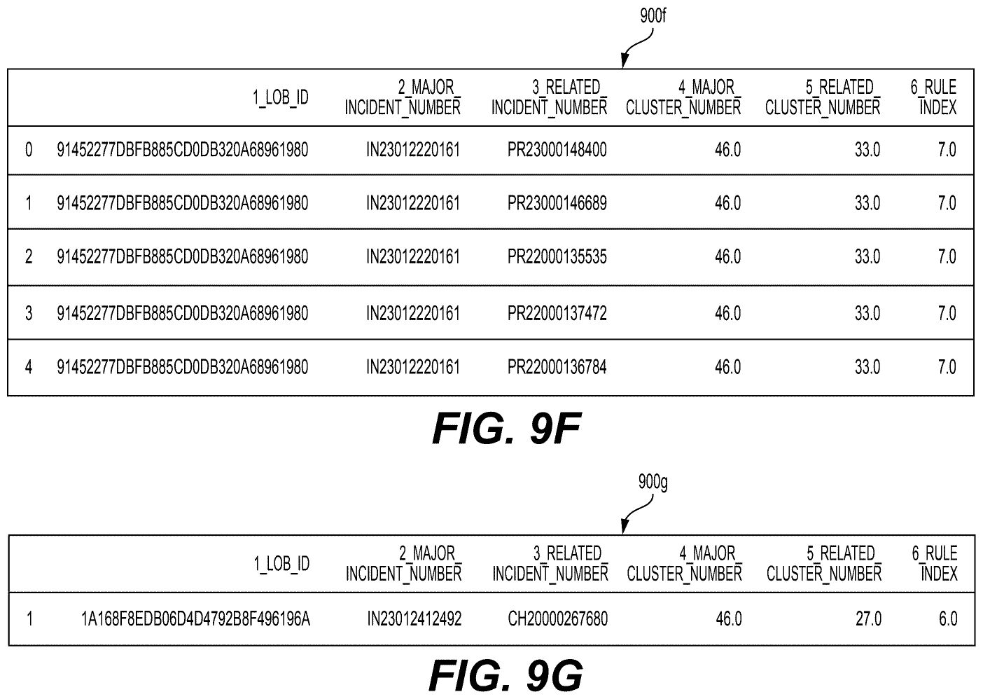

Step 308 may include generate a transaction dataset row with two columns “Start_Window” and “End_Window” and with corresponding window data. The method may include predicting and identifying cluster numbers from the cluster model (e.g., the incident cluster number described in FIG. 2) for each incident identified within the window. The assigned cluster may then be assigned a value of 1 to a table of cluster columns associated with each window as shown at the bottom of FIG. 4A. The clusters for the window may be recorded as shown in graph 404 of FIG. 4B. The process may then shift windows by the sliding value (e.g., by a five-minute shift) and perform step 308 again on the next window. This may lead to a table of transaction data being created for all incident data received at step 302. An exemplary incident-incident transaction dataset is shown in table 900a FIG. 9A. This shows how the method of FIG. 3 may be applied to each window to determine how many incidents of each cluster are found. Thus, each window may include a row identifying all clusters with respective incidents showing. The techniques of FIG. 3 may be applied to generate other transaction datasets like incident-problem, incident-change, and incident-alert. Table 900b of FIG. 9A may show a transaction dataset generated for incident-problem. Table 900c of FIG. 9A may show a transaction dataset generated for incident-change.

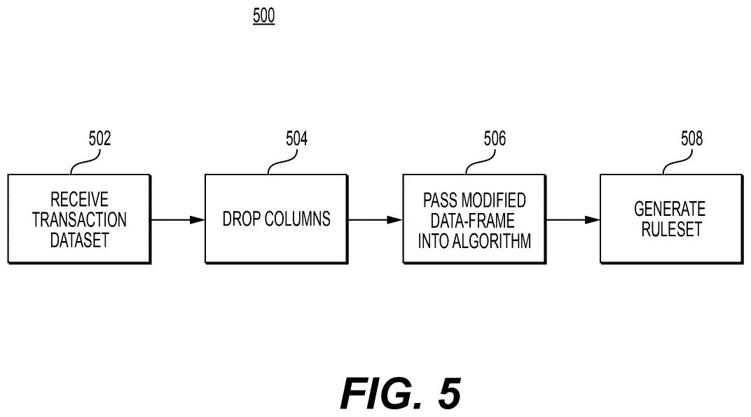

The method of 300 may be utilized to create transaction datasets. The transaction datasets may define all clusters for each type of event data that occur during a respective window for a set of data. The transaction data set may then be utilized to generate associations ruleset as described in FIG. 5. FIG. 5 depicts a flowchart 500 for a method of generating an association ruleset, according to one or more embodiments.

At step 502, the system may receive a transaction dataset. For example, the transaction dataset may have been generated by implementing the techniques of FIG. 3 may be received. An example transaction dataset may be table 900a of FIG. 9A.

At step 504 the all columns other than cluster numbers may be dropped. For example, the start window and end window columns may be removed so only a graph of clusters occurring represented by 1 and 0's remains.

At step 506, the modified data-frame from step 504 may be passed (e.g., input) into a Frequency Pattern (“FP”) growth algorithm. The FP growth algorithm may be used to discover frequent item sets in a transaction database. The FP growth algorithm may output groups of items that appear together in rows. An associated confidence for each grouping may further be determined and output by the FP growth algorithm.

At step 508, a ruleset may be generated based on the output of step 506. The ruleset may be sorted by confidence score (descending) with respect to results from step 3. The ruleset may rank whether particular clusters appear together.

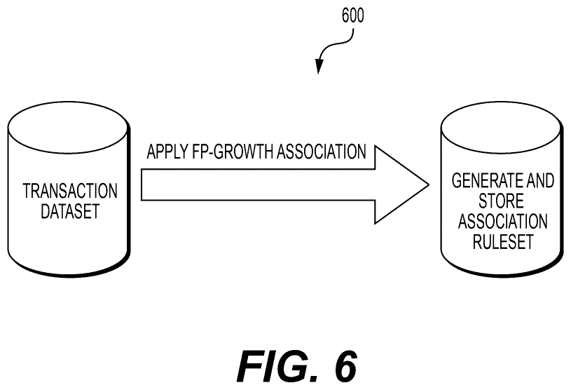

FIG. 6 depicts a flowchart 600 of generating and storing an association ruleset, according to one or more embodiments. The flowchart may show how the transaction datasets may be input into an FP growth association model to generate and store an association ruleset as described in FIG. 5 above. The method of FIG. 5 may be applied for all created transaction datasets (e.g., incident-incident, incident-problem, incident-change, and incident-alert). This may lead to four sets of association rules being generated, each one comparing incidents to one of the four event data types (e.g., incident data, change data, alert data, and problem data).

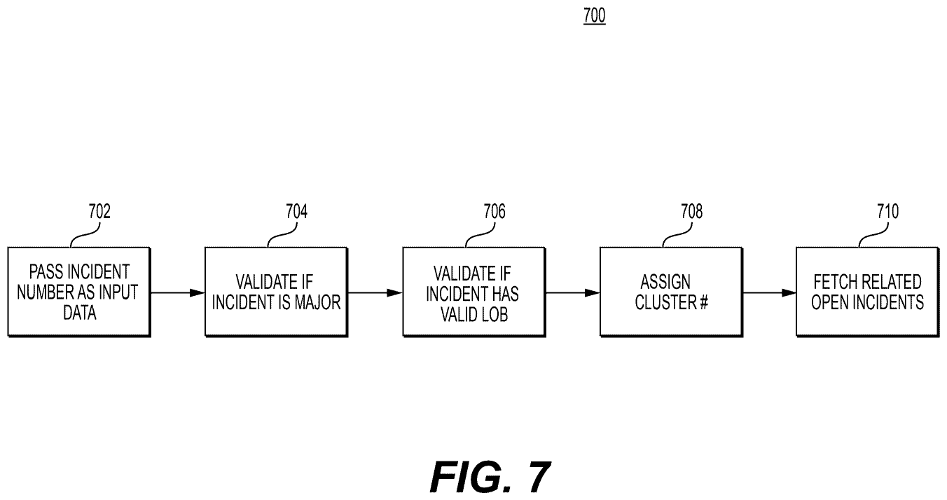

Next, using association rulesets, association rules may be generated. For example, FIG. 7 described below may describe how incident-incident associations may be determined. FIG. 7 depicts a flowchart for a method of finding historically similar incident, according to one or more embodiments.

At step 702, an incident may be received (e.g., as described above). The incident may include a description as corresponding metadata. Additional metadata may include a Line of Business Association and indication of whether an incident is major or not. At step 704, the system may first validate that the incident is major to accept the input and continue processing the input. At step 706, the system may next confirm that the LOB is valid (e.g., corresponds to a stored LOB associated or stored with the system).

At step 708, an incident cluster model may be applied to assign the incident to a particular cluster based on the short description of the incident. At step 710, the system may fetch all related open incidents under the same LOB of input incident. The system may predict a cluster number for each related open incident using a clustering model. The system may then match association rules with antecedents/consequents corresponding to major incidents. The antecedents/consequents may correspond to event data that occurred in a set period of time before and after the incident being analyzed is received. If there is an association, the system may log those incident numbers along with corresponding cluster numbers. This may then be stored as an incident-incident association.

Association rulesets based on cluster numbers along with confidence score may define incident-incident relationships. Association ruleset may be built among incident clusters (assuming N number of clusters are identified) nc c0, inc c1, . . . inc cN. A list of defined association rule sets in a list format may now be described. Similarly, incident to problem (assuming M number of problem clusters are identified) inc c0, inc c1, . . . , inc cN, prob c0, prob c1 . . . prob cM. Incident to changes: (assuming X number of change clusters are identified) inc c0, inc c1, . . . , inc cN, chng c0, chng c1 . . . chng cX. Incident to alert: (assuming Y number of alert clusters are identified) inc c0, inc c1, . . . , inc cN, alrt c0, alrt c1, . . . alrt cY.

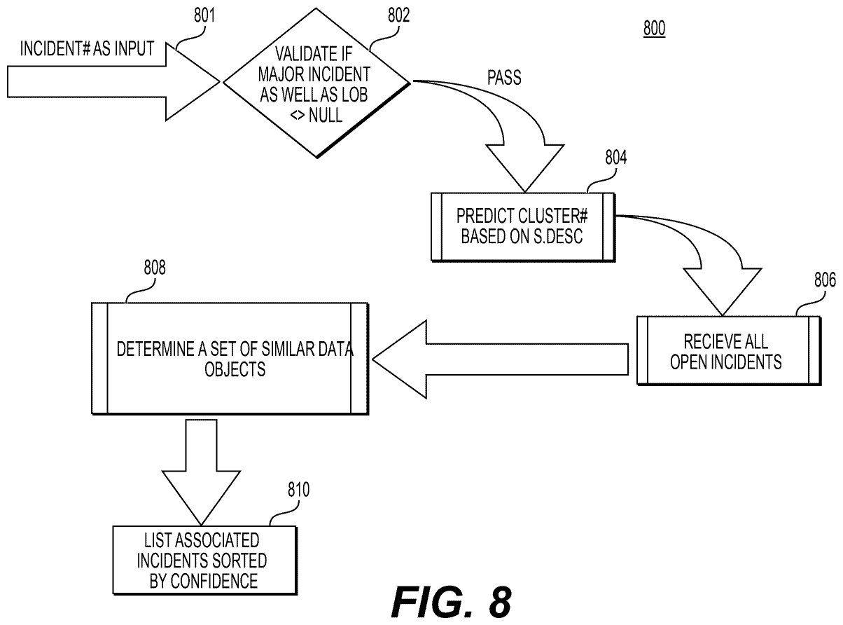

FIG. 8 depicts a flowchart 800 for a method of determining related information technology event data by applying temporal associations, according to one or more embodiments. The flowchart 800 may be performed by the data pipeline system 100 of FIG. 1.

Step 801 may include receiving an incident. For example, this may include receiving a data object indicating an occurrence of a current incident associated with a configurable item, the data object including a short description. The data object may further include metadata indicating whether the data object is major or not. The data object may further include a LOB.

Step 802 may include validating whether the data object is major. For example, the method of FIG. 8 may only be applied to incidents marked as major. This step may further include verifying that the LOB is a known LOB, by comparing the LOB with a database of acceptable LOBs for the system. If unassociated, the LOB may be indicated as null, and the method may not continue processing the incident.

Step 804 may include applying a first machine learning model to the short description of the data object to predict/determine a first cluster associated with the data object. For example, this may be performed by inputting the short description associated with the incident into a clustering model and outputting an assigned cluster number.

Step 806 may include receiving a plurality of data objects indicating occurrences of current incidents that occurred within a set period of time of the current incident, the plurality of data objects including a plurality of short descriptions. In some examples, the received plurality of data objects may be for incidents that have the same LOB.

Step 808 may include determining, based on association rules and the associated clusters, a set of similar data objects from the plurality of data objects. This may include assigning, based on the output of the association rules, a confidence score for each of data objects in the set of similar data objects. The set of similar data objects may be associated (e.g., a link may be generated) with the received incident from step 801.

Step 810 may include outputting a list of the set of similar data object to a user or storage. Step 810 may further include assigning a set of associations between the data object and the set of similar data objects. This may include creating and/or updating a graph linking the associations and corresponding confidence score. Table 900e of FIG. 9E may be an exemplary table created to display the associations. In some examples, the list of the set of similar data objects may be ranked based on the assigned confidence scores.

The above description of FIG. 8 applies to determining similar incidents. The equivalent process may further be utilized to find similar problems, change, and alert data for an incident. For example, steps 806-810 may be applied to review and determine sets of similar data objects for alert data, problem data, and change data associated with the incident received at step 801.

For example, when applying these steps to determine a set of similar problem data, this may include receiving, a plurality of problem data objects indicating occurrences of problems that occurred within the set period of time of the current incident, the plurality of problem data objects including a plurality of problem short descriptions; applying a second machine learning model to the problem short descriptions of the plurality of problem data objects to determine associated clusters for each of the plurality of problem data objects; determining, based on a second set of association rules and the associated clusters, a set of similar problem data objects from the plurality of problem data objects; assigning a second set of associations between the data object and the set of similar problem data objects; and outputting the set of similar problem data objects and/or outputting the second set of associations.

For example, when applying these steps to determine a set of similar change data, this may include receiving, a plurality of change data objects indicating occurrences of changes that occurred within the set period of time of the current incident, the plurality of change data objects including a plurality of change short descriptions; applying a third machine learning model to the change short descriptions of the plurality of change data objects to determine associated clusters for each of the plurality of change data objects; determining, based on a third set of association rules and the associated clusters, a set of similar change data objects from the plurality of change data objects; assigning a third set of associations between the data object and the set of similar change data objects; and outputting the set of similar change data objects and/or outputting the third set of associations.

For example, when applying these steps to determine a set of similar alert data, this may include receiving, a plurality of alert data objects indicating occurrences of alerts that occurred within the set period of time of the current incident, the plurality of alert data objects including a plurality of alert short descriptions; applying a fourth machine learning model to the alert short descriptions of the plurality of alert data objects to determine associated clusters for each of the plurality of alert data objects; determining, based on a fourth set of association rules and the associated clusters, a set of similar alert data objects from the plurality of alert data objects; assigning a fourth set of associations between the data object and the set of similar alert data objects; and outputting the set of similar problem data objects and/or outputting the fourth set of associations.

The method of FIG. 8 may be applied to determine a list of associations between the received incident data object of step 801 and event data that occurs within a similar temporal range of the incident data object. The method may further include outputting linked instructions on how all incidents from the first cluster were resolved to assist with resolving the cluster. The method may further include applying the method of FIG. 8 to multiple received incidents to generate a table/graph of associations between incidents that occur for a set period of time.

FIG. 9D may depict a graph 900d exemplary association ruleset generated by implementing the techniques described in FIG. 5. The antecedent and consequents of the table may each represent sets of clusters that are associated, and the confidence value may represent an assigned confidence score. In some examples, the antecedents may represent clusters of incidents, and the consequent may represent related clusters for change data.

FIG. 9E may depict a table 900e of an exemplary output of the system described herein, according to an embodiment. This may demonstrate a set of associations determined between incidents. The LOB_ID column may represent that the identified incidents all fall within a similar LOB. The 2_Major_Incident_Number column may represent the received incident (e.g., a received incident received at step 801). The 3_Related_Incident_Number column may represent associated incidents determined (e.g., at step 808). The Major 4_Major_Cluster_Number column may represent the determined cluster associated with the incident from 2_Major_Incident_Number column. The 5_Related_Cluster_Number may be the assigned cluster number from the 4_Major_Cluster_Number column. Lastly the 6_Rule Index column may represent the confidence level assigned to the association between the incidents determined based on the association's ruleset. This displays an exemplary output of associations that may be output to a user (e.g., at step 810).

FIGS. 9F and 9G display tables 900f, 900g of exemplary outputs linking incidents to problem data in table 900f and linking incident to change data in table 900g. These demonstrate additional exemplary outputs of associations that may be output to a user by implementing the techniques described herein.

One or more embodiments described herein may determine associated event data. The associations of incidents may come under a same lob and respective cluster numbers may be associated with corresponding predicted cluster numbers in association rules (antecedents/consequents), i.e., say, if major incident I1 with cluster number 10 which is in antecedents and corresponding consequents contains say, cluster number 11,2,10, then all related open incidents under same lob should match 11/2/10 to form an association with I1 once the system receives I1 as an input incident value.

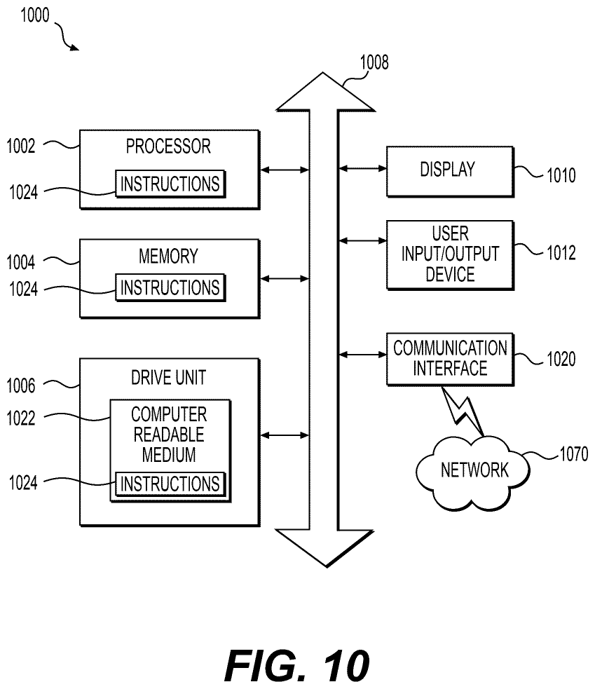

As illustrated in FIG. 10, the computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may execute a software program, such as code generated manually or automatically.

The computer system 1000 may include a memory 1004 that can communicate via a bus 1008. The memory 1004 may be a main memory, a static memory, or a dynamic memory. The memory 1004 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1004 includes a cache or random-access memory for the processor 1002. In alternative implementations, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described herein may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 1000 may further include a display unit 1010, such as a liquid crystal display (LCD), an organic light emitting diode (OLED), a flat panel display, a solid-state display, a cathode ray tube (CRT), a projector, a printer or other now known or later developed display device for outputting determined information. The display unit 1010 may act as an interface for the user to see the functioning of the processor 1002, or specifically as an interface with the software stored in the memory 1004 or in a disk or optical drive unit 1006.

Additionally or alternatively, the computer system 1000 may include a user input/output device 1012 configured to allow a user to interact with any of the components of system 1000. The device 1012 may be a number pad, a keyboard, or a cursor control device, such as a mouse, or a joystick, touch screen display, remote control, or any other device operative to interact with the computer system 1000.

The computer system 1000 may also or alternatively include the disk drive unit 1006. The disk drive unit 1006 may include a computer-readable medium 1022 in which one or more sets of instructions 1024, e.g., software, can be embedded. Further, the instructions 1024 may embody one or more of the methods or logic as described herein. The instructions 1024 may reside completely or partially within the memory 1004 and/or within the processor 1002 during execution by the computer system 1000. The memory 1004 and the processor 1002 also may include computer-readable media as discussed above.

In some systems, a computer-readable medium 1022 includes instructions 1024 or receives and executes instructions 1024 responsive to a propagated signal so that a device connected to a network 1070 can communicate voice, video, audio, images, or any other data over the network 1070. Further, the instructions 1024 may be transmitted or received over the network 1070 via a communication port or interface 1020, and/or using a bus 1008. The communication port or interface 1020 may be a part of the processor 1002 or may be a separate component. The communication port 1020 may be created in software or may be a physical connection in hardware. The communication port 1020 may be configured to connect with a network 1070, external media, the display unit 1010, or any other components in system 1000, or combinations thereof. The connection with the network 1070 may be a physical connection, such as a wired Ethernet connection or may be established wirelessly as discussed below. Likewise, the additional connections with other components of the system 1000 may be physical connections or may be established wirelessly. The network 1070 may alternatively be directly connected to the bus 1008.

While the computer-readable medium 1022 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 1022 may be non-transitory, and may be tangible.

The computer-readable medium 1022 can include a solid-state memory such as a memory card or other package that houses one or more non-volatile read-only memories. The computer-readable medium 1022 can be a random-access memory or other volatile re-writable memory. Additionally or alternatively, the computer-readable medium 1022 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 1000 may be connected to one or more networks 1070. The network 1070 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 1070 may include wide area networks (WAN), such as the Internet, local area networks (LAN), campus area networks, metropolitan area networks, a direct connection such as through a Universal Serial Bus (USB) port, or any other networks that may allow for data communication. The network 1070 may be configured to couple one computing device to another computing device to enable communication of data between the devices. The network 1070 may generally be enabled to employ any form of machine-readable media for communicating information from one device to another. The network 1070 may include communication methods by which information may travel between computing devices. The network 1070 may be divided into sub-networks. The sub-networks may allow access to all of the other components connected thereto or the sub-networks may restrict access between the components. The network 1070 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for determining related information technology event data by applying temporal associations, the method comprising:
receiving a data object indicating an occurrence of a current incident associated with a configurable item, the data object including a short description;
applying a first machine learning model to the short description of the data object to determine a first cluster associated with the data object;
receiving a plurality of data object indicating occurrences of current incidents that occurred within a set period of time of the current incident, the plurality of data objects including a plurality of short descriptions;
applying the first machine learning model to the short descriptions of the plurality of data objects to determine associated clusters for each of the plurality of data objects;
determining, based on association rules and the associated clusters, a set of similar data objects from the plurality of data objects;
assigning a set of associations between the data object and each of the set of similar data objects; and
storing the set of associations.

2. The method of claim 1, wherein the data object includes metadata of a value indicating whether the current incident is a major incident, wherein if the value indicates that the current incident is a major incident the method will proceed with applying the first machine learning model.

3. The method of claim 1, wherein determining the set of similar data objects further comprises:
assigning, based on the association rules, confidence scores for each of the similar data objects.

4. The method of claim 3, wherein outputting the set of similar data object further comprises:
outputting, the set of similar data object in a ranking based on the confidence scores for each of the similar data objects.

5. The method of claim 1, further comprising:
receiving, a plurality of problem data objects indicating occurrences of problems that occurred within the set period of time of the current incident, the plurality of problem data objects including a plurality of problem short descriptions;
applying a second machine learning model to the problem short descriptions of the plurality of problem data objects to determine associated clusters for each of the plurality of problem data objects;
determining, based on a second set of association rules and the associated clusters, a set of similar problem data objects from the plurality of problem data objects;
assigning a second set of associations between the data object and the set of similar problem data objects; and
outputting the second set of associations.

6. The method of claim 1, further comprising:
receiving, a plurality of change data objects indicating occurrences of changes that occurred within the set period of time of the current incident, the plurality of change data objects including a plurality of change short descriptions;
applying a third machine learning model to the change short descriptions of the plurality of change data objects to determine associated clusters for each of the plurality of change data objects;
determining, based on a third set of association rules and the associated clusters, a set of similar change data objects from the plurality of change data objects;
assigning a third set of associations between the data object and the set of similar change data objects; and
outputting the third set of associations.

7. The method of claim 1, further comprising:
receiving, a plurality of alert data objects indicating occurrences of alerts that occurred within the set period of time of the current incident, the plurality of alert data objects including a plurality of alert short descriptions;
applying a fourth machine learning model to the alert short descriptions of the plurality of alert data objects to determine associated clusters for each of the plurality of alert data objects;
determining, based on a fourth set of association rules and the associated clusters, a set of similar alert data objects from the plurality of alert data objects;
assigning a fourth set of associations between the data object and the set of similar alert data objects; and
outputting the fourth set of associations.

8. A system for determining related information technology event data in a system, the system comprising:
a memory having processor-readable instructions stored therein; and
at least one processor configured to access the memory and execute the processor-readable instructions to perform operations including:
receiving a data object indicating an occurrence of a current incident associated with a configurable item, the data object including a short description;
applying a first machine learning model to the short description of the data object to determine a first cluster associated with the data object;
receiving a plurality of data object indicating occurrences of current incidents that occurred within a set period of time of the current incident, the plurality of data objects including a plurality of short descriptions;
applying the first machine learning model to the short descriptions of the plurality of data objects to determine associated clusters for each of the plurality of data objects;
determining, based on association rules and the associated clusters, a set of similar data objects from the plurality of data objects; and
outputting the set of similar data object.

9. The system of claim 8, further including:
the data object including a value indicating whether the current incident is a major incident, wherein if the current incident is a major incident, applying the first machine learning model.

10. The system of claim 8, wherein determining the set of similar data objects further comprises:
assigning, based on the association rules, confidence scores for each of the similar data objects.

11. The system of claim 10, wherein outputting the set of similar data object further comprises:
outputting, the set of similar data object in a ranking based on the confidence scores for each of the similar data objects.

12. The system of claim 8, further comprising:
receiving, a plurality of problem data objects indicating occurrences of problems that occurred within the set period of time of the current incident, the plurality of problem data objects including a plurality of problem short descriptions;
applying a second machine learning model to the problem short descriptions of the plurality of problem data objects to determine associated clusters for each of the plurality of problem data objects;
determining, based on a second set of association rules and the associated clusters, a set of similar problem data objects from the plurality of problem data objects;
assigning a second set of associations between the data object and the set of similar problem data objects; and
outputting the second set of associations.

13. The system of claim 8, further comprising:
receiving, a plurality of change data objects indicating occurrences of changes that occurred within the set period of time of the current incident, the plurality of change data objects including a plurality of change short descriptions;
applying a third machine learning model to the change short descriptions of the plurality of change data objects to determine associated clusters for each of the plurality of change data objects;
determining, based on a third set of association rules and the associated clusters, a set of similar change data objects from the plurality of change data objects;
assigning a third set of associations between the data object and the set of similar change data objects; and
outputting the third set of associations.

14. The system of claim 8, further comprising:
receiving, a plurality of alert data objects indicating occurrences of alerts that occurred within the set period of time of the current incident, the plurality of alert data objects including a plurality of alert short descriptions;
applying a fourth machine learning model to the alert short descriptions of the plurality of alert data objects to determine associated clusters for each of the plurality of alert data objects;
determining, based on a fourth set of association rules and the associated clusters, a set of similar alert data objects from the plurality of alert data objects;
assigning a fourth set of associations between the data object and the set of similar alert data objects; and
outputting the fourth set of associations.

15. A non-transitory computer readable medium storing processor-readable instructions which, when executed by at least one processor, cause the at least one processor to perform operations including:
receiving a data object indicating an occurrence of a current incident associated with a configurable item, the data object including a short description;
applying a first machine learning model to the short description of the data object to determine a first cluster associated with the data object;
receiving a plurality of data object indicating occurrences of current incidents that occurred within a set period of time of the current incident, the plurality of data objects including a plurality of short descriptions;
applying the first machine learning model to the short descriptions of the plurality of data objects to determine associated clusters for each of the plurality of data objects;
determining, based on association rules and the associated clusters, a set of similar data objects from the plurality of data objects;
assigning a set of associations between the data object and each of the set of similar data objects; and
storing the set of associations.

16. The non-transitory computer readable medium of claim 15, wherein the data object includes metadata of a value indicating whether the current incident is a major incident, wherein if the value indicates that the current incident is a major incident the non-transitory computer readable medium will proceed with applying the first machine learning model.

17. The non-transitory computer readable medium of claim 15, wherein determining the set of similar data objects further comprises:
assigning, based on the association rules, confidence scores for each of the similar data objects.

18. The non-transitory computer readable medium of claim 17, wherein outputting the set of similar data object further comprises:
outputting, the set of similar data object in a ranking based on the confidence scores for each of the similar data objects.

19. The non-transitory computer readable medium of claim 15, further comprising:
receiving, a plurality of problem data objects indicating occurrences of problems that occurred within the set period of time of the current incident, the plurality of problem data objects including a plurality of problem short descriptions;
applying a second machine learning model to the problem short descriptions of the plurality of problem data objects to determine associated clusters for each of the plurality of problem data objects;
determining, based on a second set of association rules and the associated clusters, a set of similar problem data objects from the plurality of problem data objects;
assigning a second set of associations between the data object and the set of similar problem data objects; and
outputting the second set of associations.

20. The non-transitory computer readable medium of claim 15, further comprising:
receiving, a plurality of change data objects indicating occurrences of changes that occurred within the set period of time of the current incident, the plurality of change data objects including a plurality of change short descriptions;
applying a third machine learning model to the change short descriptions of the plurality of change data objects to determine associated clusters for each of the plurality of change data objects;
determining, based on a third set of association rules and the associated clusters, a set of similar change data objects from the plurality of change data objects;
assigning a third set of associations between the data object and the set of similar change data objects; and
outputting the third set of associations
